(19) United States
(12) Patent Application Publication
(10) Pub. No.: US 2021/0010627 A1
(43) Pub. Date: Jan. 14, 2021

(54) A PRESSURE FLUCTUATION DAMPER FOR A METERING INSTRUMENT AND A METHOD FOR MOUNTING THE SAME

(71) Applicant: Serhii Anatolijovich MORHUN, Energodar (UA)

(72) Inventors: Serhii Anatolijovich MORHUN, Energodar (UA); Maryna Anatoliivna MORHUN, Energodar (UA); Andrii Sergijovych MORHUN, Odesa (UA); Fedir Sergijovych MORHUN, Energodar (UA)

(21) Appl. No.: 16/976,777

(22) PCT Filed: Jul. 31, 2019
(86) PCT No.: PCT/IB2019/056532

§ 371 Date: Aug. 31, 2020

(30) Foreign Application Priority Data
Oct. 22, 2018 (UA) A 2018 10443

(51) Int. Cl. F16L 55/04

(52) U.S. Cl. CPC F16L 55/043

(57) ABSTRACT

A pressure fluctuation damper for a metering instrument (10) located at an end of a pulse tube (9), which comprises a generally elongated cylindrical element (2) comprising one or more intake throttling channels (4) in fluid communication with the pulse tube (9) and one or more outlet damping channels (5) in fluid communication with the metering instrument (10), the elongated cylindrical element (2) being equipped with an end face thrust element (3) located coaxially to the pulse tube (9), the diameter of the elongated cylindrical element (2) being smaller than the inner diameter of the pulse tube (9) and the diameter of the end face thrust element (3) being larger than the inner diameter of the pulse tube (9); and a method for mounting the pressure fluctuation damper.

### TECHNICAL FIELD

The solution as claimed relates to the field of machinery manufacturing and is intended for protection of monitoring and metering instruments (MMI) from the negative effects of pulsing fluids, for damping of MMI signals, which are used in automatic regulation, protection and locking systems in order to increase their reliability and prevent system failures of “error” type, which are used in industry, power generation, pipeline transport, heat and water supply systems.

### BACKGROUND ART

At present, constructions of pressure fluctuation dampers for metering instruments envisage their mounting between pulse tubes and a metering instrument, while the dimensions of the mainline are increased by the size of the damper itself, which complicates and sometimes renders impossible the mounting and maintenance of the dampers under the conditions of limited space of premises. Also a deficiency of the known construction variants of pressure fluctuation dampers for MMI is that their mounting involves the creation of two connection points between a damper, an MMI and a pulse tube, which, in turn, reduces reliability of the construction due to the increase in the number of the mainline connection areas exposed to increased mechanical loads.

Thus, there is still a current need to develop such a construction of a pressure fluctuation damper for a metering instrument and a method for mounting the same, which will rectify the above-mentioned deficiencies.

The closest analogue of the claimed solution is a pressure fluctuation damper for a pressure gauge, described in the USSR author's certificate No. 15/90,760, which comprises throttling channels, a damping channel and elements for connecting the damper with the mainline, provided at the ends of the device.

### Technical Problem

The deficiency of said device is the lack of possibility for its mounting in a controlled system without increasing its overall dimensions, as well as without forming two units for connecting the damper with the MMI and the mainline.

### Solution to Problem

The object of the invention is to develop a pressure fluctuation damper for a metering instrument, as well as a method for mounting the same, with the optimal construction of the damper, which also determines the optimal set of operations during implementation of the method for its mounting, being aimed at achieving the technical result, which is to make the mounting easier and to perform periodic maintenance of the damper while preserving the overall dimensions of the entire controlled system in general, which, in turn, allows for increasing reliability of the measurements performed.

The set problem is solved by developing a pressure fluctuation damper for a metering instrument located at an end of a pulse tube directly upstream the MMI in a standard connection unit, which comprises a generally elongated cylindrical element comprising one or more intake throttling channels in fluid communication with the pulse tube and one or more outlet damping channels in fluid communication with the metering instrument, the elongated cylindrical element being equipped with an end face thrust element located coaxially to the pulse tube, the diameter of the elongated cylindrical element being smaller than the inner diameter of the pulse tube and the diameter of the end face thrust element being larger than the inner diameter of the pulse tube. It should be kept in mind that the inlet of the intake throttling channel is provided on the outer surface of the elongated cylindrical element.

In a preferred embodiment of the invention the elongated cylindrical element outer surface is provided with a helical groove in communication with one or more annular grooves, in their turn, being in communication with the inlet of the intake throttling channel.

An embodiment is appropriate where the outlet damping channel is divided with one or more partitions into chambers being in fluid communication with each other by means of one or more through channels provided in the partition. In this case, the outlet damping channel may be of any shape that facilitates the most effective damping of fluid fluctuations.

Also, the set problem is solved by the fact that a method for mounting a pressure fluctuation damper for metering instruments is developed, wherein the elongated cylindrical element is placed inside the pulse tube, and the end face thrust element is clamped between the surfaces of the pulse tube and metering instrument which are in communication. In this case, the surfaces which are in communication should be understood as the end face surfaces of the metering instrument connecting pipe and of the pulse tube, and the end face thrust element is clamped by means of a detachable or threaded, or clamped, or flanged connection, or any other connection that allows for fixation of the elongated cylindrical element inside the pulse tube.

However, it will be apparent to those skilled in the art that the embodiments of the basic features characterizing the claimed pressure fluctuation damper for a metering instrument and the method for mounting the same are given as an example only and are not limiting and/or exhaustive. The dimensions, proportions, shapes and profiles of the elements shown herein are schematic and may differ in the embodiments of the device, depending on the calculations, characteristics and properties of the working fluid, and the required set of functions.

Thus, the overall dimensions of the control system are preserved thanks to the fact that the pressure fluctuation damper for a metering instrument is located directly inside the already existing mainline. Said possibility is ensured by the fact that in the mounted condition, in general, the elongated cylindrical element of the damper uses the space of the pulse tube inner channel, and the end face thrust element is located and fixed inside the unit connecting the MMI and the mainline. Reliability of the controlled system is increased due to the fact that when mounting the damper in accordance with said method there is no increase in the number of connection points between the various elements of the system that are exposed to increased mechanical loads, and reliability of the measurements performed is increased due to the structural features of said preferred embodiment of the damper construction, in particular, due to the presence of a helical groove and annular grooves and one or more throttling channels reducing the fluid pressure on the MMI, as well as a damping channel divided into several chambers, which reduces the effects of possible fluid fluctuations on the MMI operation.

### BRIEF DESCRIPTION OF DRAWINGS

The solution as claimed is explained by means of the following drawings.

FIG. 1 is a general view of a pressure fluctuation damper for a metering instrument.

FIG. 2 is a longitudinal section view of a pressure fluctuation damper for a metering instrument.

FIG. 3 is a cross section view of a pressure fluctuation damper for a metering instrument in plane A-A.

FIG. 4 is a longitudinal section view of a pressure fluctuation damper for a metering instrument in the mounted state.

### DESCRIPTION OF EMBODIMENTS

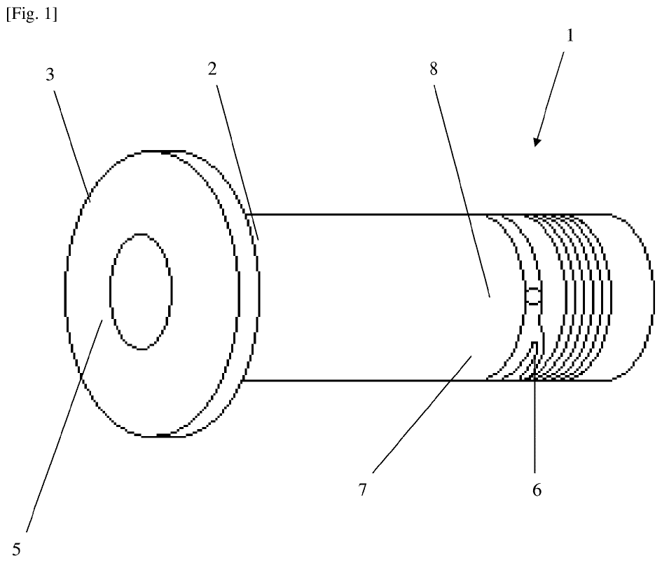

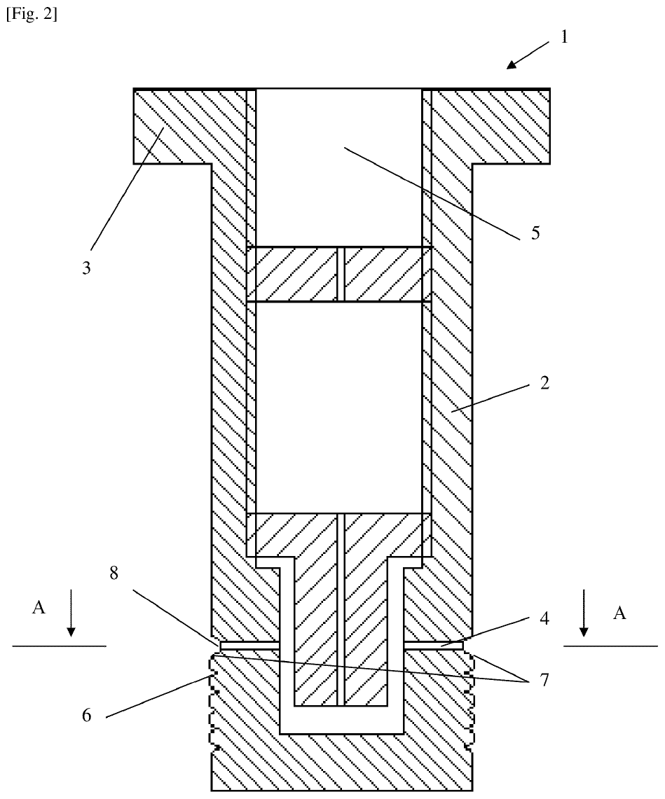

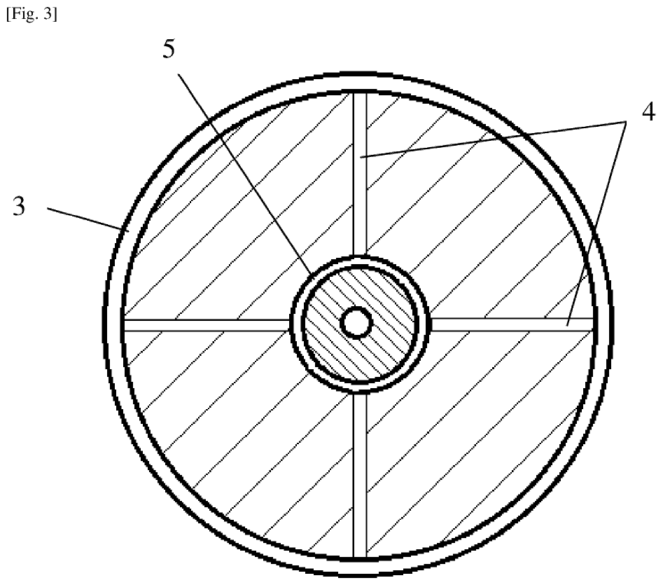

FIGS. 1-3 show a pressure fluctuation damper (1) for a metering instrument, comprising a generally elongated cylindrical element (2) equipped with an end face thrust element (3), comprising one or more intake throttling channels (4) (FIGS. 2 and 3) in fluid communication with a pulse tube (not shown in the figures) and one or more outlet damping channels (5) in fluid communication with the metering instrument (not shown in the figures). The elongated cylindrical element (2) outer surface is provided with a helical groove (6) in communication with one or more annular grooves (7), in their turn, being in communication with the inlet (8) of the intake throttling channel (4).

FIG. 3 is a cross section view of the damper in plane A-A.

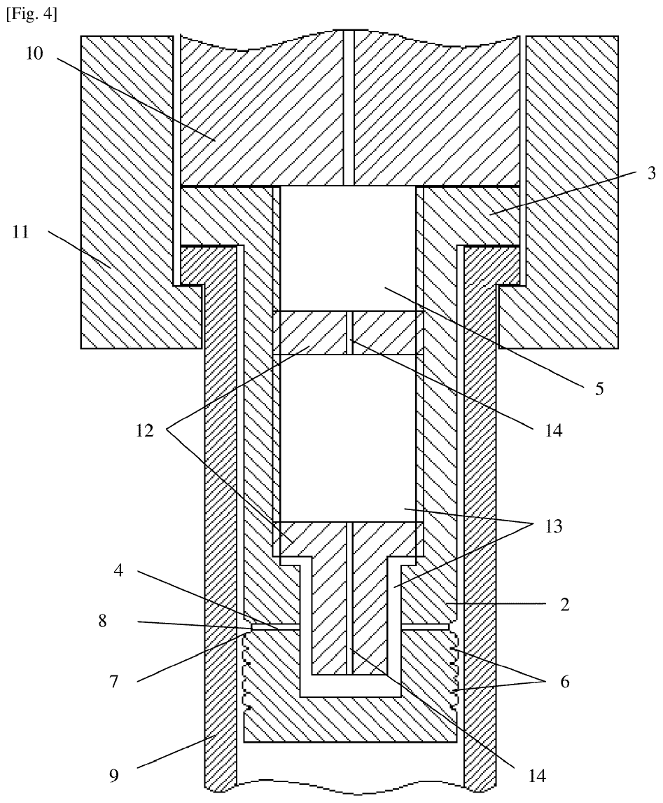

FIG. 4 shows the damper in the mounted state, wherein its generally elongated cylindrical element (2) is placed inside the inner channel of the pulse tube (9), and the end face thrust element (3) is clamped with the end face surface of the pulse tube (9) to the end face surface of the connecting pipe of the monitoring and metering instrument (10) and fixed by means of coupling nut (11). In the embodiment of the invention as shown the outlet damping channel (5) is divided with partitions (12) into chambers (13), being in fluid communication with each other and the damping channel by means of through channels (14) provided in the partitions.

### INDUSTRIAL APPLICABILITY

The solution as claimed is implemented as follows.

Thanks to its diameter being smaller than the inner diameter of the pulse tube (9) the elongated cylindrical element (2) of the pressure fluctuation damper (1) for the metering instrument (10) is inserted into its inner channel, the insertion depth being limited due to the presence of the end face thrust element (3), the diameter of which is larger than the inner diameter of the pulse tube (9). The end face thrust element (3) is clamped with the end face surface of the pulse tube (9) to the end face surface of the connecting pipe of the monitoring and metering instrument (10) and fixed, for example, by means of coupling nut (11), with only one unit connecting the MMI and the mainline being formed in this case.

The effective damping of fluctuations and pulsations of the fluid during its transfer to the monitoring and metering instrument (10) by means of the mounted damper (1) is carried out by passing the fluid through the channel formed by the walls of the inner channel of the pulse tube (9) and the helical groove (6) being, in its turn, in communication with the annular groove (7) through the intake throttling channels (4) to the outlet damping channel (5). Further, the energy of the working fluid fluctuations and pulsations is damped by means of the effects of changing the direction of the pulsation propagation in a rotary mixing chamber, the interaction of the working fluid streams when mixing, throttling into the chamber, through the intake throttling channels (4), swirling and due to the variable diameter of the outlet damping channel (5), through which it passes to the monitoring and metering instrument (10). The swirling effect is achieved when the fluid is fed into the outlet damping channel (5) through several intake throttling channels (4) oppositely directed inside it, and the variable diameter is arranged by means of formation of chambers (13) separated with partitions (12).

Thus, a pressure fluctuation damper for a metering instrument, as well as a method for mounting the same are developed, with the optimal construction of the damper, which also determines the optimal set of operations during implementation of the method for its mounting, being aimed at achieving the technical result, which is to make the mounting easier and to perform periodic maintenance of the damper while preserving the overall dimensions of the entire controlled system in general, which, in turn, allows for increasing reliability of the measurements performed.

1. A pressure fluctuation damper for a metering instrument located at an end of a pulse tube, comprising a generally elongated cylindrical element comprising one or more intake throttling channels in fluid communication with the pulse tube and one or more outlet damping channels in fluid communication with the metering instrument, characterized in that the elongated cylindrical element is equipped with an end face thrust element located coaxially to the pulse tube wherein the diameter of the elongated cylindrical element is smaller than the inner diameter of the pulse tube and the diameter of the end face thrust element is larger than the inner diameter of the pulse tube.

2. The pressure fluctuation damper for a metering instrument according to claim 1, wherein the elongated cylindrical element outer surface is provided with one or more annular grooves.

3. The pressure fluctuation damper for a metering instrument according to claim 1, wherein the elongated cylindrical element outer surface is provided with a helical groove.

4. The pressure fluctuation damper for a metering instrument according to claim 1, wherein the outlet damping channel is divided with one or more partitions into chambers being in fluid communication with each other by means of one or more through channels provided in the partition.

5. A method for mounting the damper according to claims 1-4, wherein the elongated cylindrical element is placed inside the pulse tube, and the end face thrust element is clamped between surfaces of the pulse tube and the metering instrument which are connected.

6. The method for mounting the pressure fluctuation damper for metering instruments according to claim 5, wherein the end face thrust element is clamped between the surfaces of the pulse tube and the metering instrument which are connected and fixed with a flanged connection, or a threaded connection, or a clamped connection.
